(19) United States
(12) Patent Application Publication
(10) Pub. No.: US 2003/0002646 A1
(43) Pub. Date: Jan. 2, 2003

(54) Intelligent phone router

(75) Inventors: Srinivas Gutta, Buchanan, NY (US); Larry Eshelman, Ossining, NY (US); Hugo J. Strubbe, Yorktown Heights, NY (US); John Milanski, Boulder, CO (US)

Correspondence Address: Corporate Patent Counsel, U.S. Philips Corporation, 580 White Plains Road, Tarrytown, NY, 10591, US

(73) Assignee: Philips Electronics North America Corp.

(21) Appl. No.: 09/893,260

(22) Filed: Jun. 27, 2001

(51) Int. Cl. H04M 11/00; H04M 7/00; G06K 9/00

(52) U.S. Cl. 379/220.01; 379/258; 379/93.03; 382/115

(57) ABSTRACT

A system and method for directing an incoming telephone call. The system comprises a control unit that receives images associated with two or more regions of a local environment. The two or more regions are each serviced by a respective telephone extension. The control unit processes the images to identify, from a group of known persons associated with the local environment, any one or more known persons located in the respective regions. For each known person so identified, an indicium is generated that associates the known person with the respective region in which the known person is located.

### FIELD OF THE INVENTION

The invention relates to routing of telephone calls and other telecommunications services, in particular within a local environment, such as a home or office.

### BACKGROUND OF THE INVENTION

Certain techniques for routing calls within a local environment are known. In a simple example, a small office has a number of telephone extensions that connect with a switchboard. An operator receives an incoming call, inquires who the caller wishes to speak with, and manually attaches the call to the extension of the desired recipient. If the recipient is not at his or her desk, the operator may page the recipient and, if the recipient responds from another extension in the office, route the call to the other extension. Alternatively, the operator may route the call into a voice mailbox for the desired recipient. This technique is disadvantageous because, among other reasons, it relies on manual routing of the call by the operator. Also, when the recipient is not at an assigned extension, it requires a manual search by the operator, as well as a response by the recipient. Thus, the recipient may not receive the call even if he or she is available.

In a similar example, an incoming call may be routed to an extension of a desired recipient in an office or other local environment via a automated routing system, such as a private branch exchange (PBX) system. In such a system, after the call is picked up, the caller is prompted via an automated response to input the name or extension of the desired recipient. The system then routes the call to the selected extension of the recipient. This technique is disadvantageous because, among other things, it requires that the intended recipient be at an assigned extension (or, perhaps, an extension to where the call is forwarded) in order to receive the call. It does not route the call to a different extension even if the recipient is available for the call.

Other more sophisticated call routing techniques and systems exist. For example, PCT Application WO 00/22805 describes a telephone management system that controls routing within an office by a PBX. When a caller places a call to a recipient in the office, the PBX receives caller ID data and signaling relating to the destination number related to the recipient. Before the call is routed, the telephone management system determines the identity of the recipient based upon the destination number. The telephone management system searches a database for routing instructions for the recipient that may be programmed in by the recipient. The particular instruction retrieved for the recipient may be based on the caller (as determined by the caller ID), the time, day and date. The call is routed by the PBX based on the applicable instruction. Among other deficiencies, this system requires that the users (recipients) diligently follow or update their programmed instructions.

UK Patent Application No. 2222503A describes a PABX (private automatic branch exchange) system that has a number of telephone extensions and telephone sets. A plurality of receivers are also located in proximity to or within the telephone sets. Users of the system each carry a transceiver that provide a signal to the nearest receiver thereby identifying the user's location. The system uses the caller's location to route the call to the nearest extension. The signal from the transceiver may also include the user's status, which may result in the system routing the call elsewhere. For example, if the user status signal indicates he or she is at lunch, the call may be routed to voicemail. Among other deficiencies, this system requires that the users diligently carry the transceivers and update the status signal emitted.

European Patent Application EP 0905956A2 describes a system that routes calls to a wireless terminal of an agent having particular knowledge or skill at a particular location. An example given is an employee that has advance knowledge of power tools located in the tool department of a store. If such an agent is not available at the particular location (or is busy), the call is routed to a wireless terminal of another agent having the appropriate (or some) pertinent knowledge or skill in another location. The system identifies the location of the agents based on information obtained from the system's base stations. Among other deficiencies, this system also requires that the agents diligently carry the transceivers and update their knowledge or skill set with the system.

In short, the known routing techniques require manual routing of calls, user programming of routing instructions and/or a user carrying a transceiver. The known techniques fail to provide automatic routing of calls to a user based on the user's location.

### SUMMARY OF THE INVENTION

It is thus an objective of the invention to provide automatic routing of calls in a local environment. It is also an objective to provide automatic detection of the location of a particular user in a local environment and automatic routing of a call for the particular user to the nearest telephone extension. It is also an objective to provide automatic detection of the location of a particular user in a local environment using image recognition and/or voice recognition.

Accordingly, the invention provides a system comprising a control unit that receives images associated with two or more regions of a local environment. The two or more regions are each serviced by a respective telephone extension. The control unit processes the images to identify, from a group of known persons associated with the local environment, any one or more known persons located in the respective regions. For each known person so identified, an indicium is generated that associates the known person with the respective region in which the known person is located.

In addition, the invention provides a system comprising a control unit that receives images associated with two or more regions of a local environment. The two or more regions are each serviced by a respective telephone branch. The control unit processes the images to detect any persons located in the respective regions. An incoming call is switched by the control unit to at least one of the respective telephone branches in which at least one detected person is located.

Also, the invention provides a method for directing an incoming telephone call. The method comprises capturing images associated with each of a number of regions of a local environment. From a group of known persons each associated with the local environment, any known persons in each of the number of regions are identified from the captured images associated with each of the number of regions. A desired recipient of the incoming call is also identified and it is determined whether the desired recipient is one of the known persons identified in one of the regions. Where the desired recipient is one of the known persons identified in one of the regions, the incoming call is connected to an extension servicing the respective region in which the desired recipient is located.

In addition, the invention provides an alternative method for directing an incoming telephone call. Images associated with each of a number of regions of a local environment are captured. Any persons located in each of the number of regions are detected from the captured images associated with each of the number of region. An incoming call is connected to an extension servicing at least one of the regions in which at least one person is located.

### BRIEF DESCRIPTION OF THE DRAWINGS

FIG. 1 is a representative view of an embodiment of the invention;

FIG. 1a depicts further details of a component of FIG. 1;

FIG. 2 is a representative view of a second embodiment of the invention.

### DETAILED DESCRIPTION

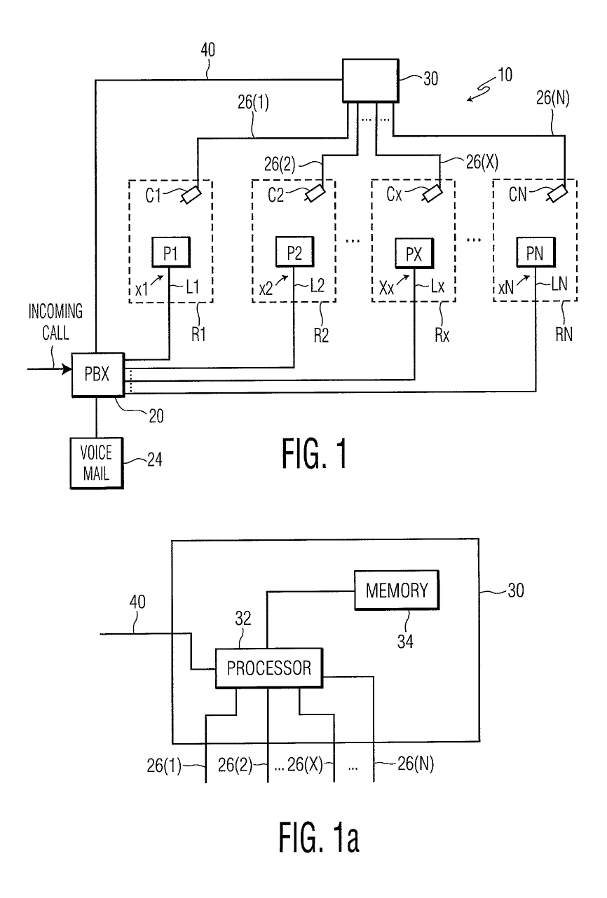

Referring to FIG. 1, a local environment 10 is represented that is serviced by a number of telephone sets or phones P1, P2, . . . PN connected to a private branch exchange PBX 20. Although phones P1, P2, . . . , PN are referred to, it is understood that these may be any device that is used to answer a call, including any display surface, such as, for example, a dynamic photograph. The local environment 10 may be any setting that is serviced by such a PBX configuration, such as an office, home, store, hospital, etc. For convenience, the ensuing description will focus on an office environment. However, the system may be easily adapted to other settings by one skilled in the art.

Each phone P1, P2, . . . PN provides a separate extension of the PBX 20. Each phone P1, P2, . . . PN is connected via a separate line L1, L2, . . . , LN, respectively, to the PBX 20. As is known in the art, PBX 20 switches an incoming call to a desired extension by switching the incoming call to the appropriate line (either L1, L2, . . . or LN), thereby routing the call to the phone servicing that extension (either P1, P2, . . . or PN). (Although only one “incoming call” to the PBX 20 is shown in FIG. 1, it is generally the case that PBX 20 will have a number of connections to the public switching telephone network (PSTN).) The extensions of PBX 20 are given reference numbers X1, X2, . . . XN in FIG. 1. Thus, extension X1 is represented as comprised of phone P1, line L1 and the pertinent switching connections of PBX 20. The other extensions are analogously described. The phones P1, P2, . . . PN for each extension X1, X2, . . . , XN are shown as servicing a particular region R1, R2, . . . , RN, respectively, of the office 10. The particular regions may be, for example, an individual office, a conference room, a lunch room, etc. Switching of an incoming call to an appropriate extension X1, X2, . . . , or XN may be made based on signaling that the PBX 20 receives from the caller after the incoming call is picked up. For example, the caller may identify the desired recipient by providing (via touch tone or by speaking, for example) all or portion of the recipient's name. In a standard mode of operation, the PBX 20 then switches the call to a particular extension (X1, X2, or XN) that is assigned to the desired recipient. Alternatively, the caller may identify the desired recipient by providing the extension number for the extension (X1, X2, . . . , or XN) that is assigned to the desired recipient and the PBX 20 then switches the call to the identified extension. Where the extension services a region that is not assigned to a particular recipient, such as a conference room or lunch room, analogous procedures may apply. If the extension is busy or not answered after a number of rings, the call may be switched by PBX 20 to the recipient's mailbox in voicemail 24.

Each region R1, R2, . . . , RN includes an image capturing device, such as a camera C1, C2, . . . , CN. Data lines 26(1), 26(2), . . . , 26(N) connect cameras C1, C2, . . . , CN, respectively, to server or control unit 30. (Alternatively, data lines 26(1), 26(2), . . . 26(N) may connect to a multiplexer wherein the images from each camera may be transmitted in a multiplexed fashion to a single input of the control unit 30.) Each camera thus provides images of the respective region in which it is located to the control unit 30. Thus, for example, camera C1 provides images of region R1 to control unit 30.

Control unit 30 may comprise, for example, a processor 32 and memory 34 and run image recognition software, as shown further in FIG. 1a. The image recognition software processes the incoming images of each region R1, R2, . . . , RN, received from cameras C1, C2, . . . , CN, respectively. For convenience, the ensuing description will focus on the images received from a single camera, Cx, of a single region, Rx, shown in FIG. 1. The description is representative of images received from any of the other cameras C1, C2, . . . , CN located in regions R1, R2, . . . , RN shown in FIG. 1. It is further noted that region Rx is also served by extension Xx, comprised of phone Px and line Lx, which are also representative of the extensions of the other regions shown in FIG. 1.

As noted, camera Cx captures images of region Rx and transmits the image data to control unit 30. The images are typically comprised of pixel data, for example, those from a CCD array in a typical digital camera. The pixel data of the images is assumed to be pre-processed into a known digital format that may be further processed using the image recognition software in control unit 30. Such pre-processing of the images may take place in a processor of the camera Cx. Such processing of images by digital cameras (which provides the pre-processed image data to the control unit 30 for further processing by the image recognition software) is well known in the art and, for convenience, it's description will be omitted except to the extent necessary to describe the invention. While such pre-processing of the images of camera Cx may take place in the camera Cx, it may alternatively take place in the processor 32 of control unit 30 itself.

Processor 32 includes known image recognition software loaded therein that analyzes the image data received from camera Cx via data line 26(x). If a person is located in region Rx, he or she will thus be depicted in the image data. The image recognition software may be used, for example, to recognize the contours of a human body in the image, thus recognizing the person in the image. Once the person's body is located, the image recognition software may be used to locate the person's face in the received image and to identify the person.

For example, if control unit 30 receives a series of images from camera Cx, control unit 30 may detect and track a person that moves into the region Rx covered by camera Cx and, in particular, may detect and track the approximate location of the person's head. Such a detection and tracking technique is described in more detail in “Tracking Faces” by McKenna and Gong, Proceedings of the Second International Conference on Automatic Face and Gesture Recognition, Killington, Vt., Oct. 14-16, 1996, pp. 271-276, the contents of which are hereby incorporated by reference. (Section 2 of the aforementioned paper describes tracking of multiple motions.)

When the person is stationary in region Rx, for example, when he or she sits in a chair, the movement of the body (and the head) will be relatively stationary. Where the software of the control unit 30 has previously tracked the person's movement in the image, it may then initiate a separate or supplementary technique of face detection that focuses on the portion of the subsequent images received from the camera Cx where the person's head is located. If the software of the control unit 30 does not track movements in the images, then the person's face may be detected using the entire image, for example, by applying face detection processing in sequence to segments of the entire image.

For face detection, the control unit 30 may identify a static face in an image using known techniques that apply simple shape information (for example, an ellipse fitting or eigen-silhouettes) to conform to the contour in the image. Other structure of the face may be used in the identification (such as the nose, eyes, etc.), the symmetry of the face and typical skin tones. A more complex modeling technique uses photometric representations that model faces as points in large multi-dimensional hyperspaces, where the spatial arrangement of facial features are encoded within a holistic representation of the internal structure of the face. Face detection is achieved by classifying patches in the image as either “face” or “non-face” vectors, for example, by determining a probability density estimate by comparing the patches with models of faces for a particular sub-space of the image hyperspace. This and other face detection techniques are described in more detail in the aforementioned Tracking Faces paper.

Face detection may alternatively be achieved by training a neural network supported within the control unit 30 to detect frontal or near-frontal views. The network may be trained using many face images. The training images are scaled and masked to focus, for example, on a standard oval portion centered on the face images. A number of known techniques for equalizing the light intensity of the training images may be applied. The training may be expanded by adjusting the scale of the training face images and the rotation of the face images (thus training the network to accommodate the pose of the image). The training may also involve back-propagation of false-positive non-face patterns. The control unit 30 provides portions of the image to such a trained neural network routine in the control unit 30. The neural network processes the image portion and determines whether it is a face image based on its image training.

The neural network technique of face detection is also described in more detail in the aforementioned Tracking Faces paper. Additional details of face detection (as well as detection of other facial sub-classifications, such as gender, ethnicity and pose) using a neural network is described in “Mixture of Experts for Classification of Gender, Ethnic Origin and Pose of Human Faces” by Gutta, Huang, Jonathon and Wechsler, IEEE Transactions on Neural Networks, vol. 11, no. 4, pp. 948-960 (July 2000), the contents of which are hereby incorporated by reference and referred to below as the “Mixture of Experts” paper.

Once a face is detected in the image, the control unit 30 provides image recognition processing to the face to identify the person. Thus, the image recognition processing may be programmed to recognize particular faces, and each face is correlated to the identity of a person. The neural network technique of face detection described above may be adapted for identification by training the network using the faces of those persons who must be identified. Faces of other persons may be used in the training as negative matches (for example, false-positive indications). Thus, a determination by the neural network that a portion of the image contains a face image will be based on a training image for a known (identified) person, thus simultaneously providing the identification of the person. So programmed, the neural network provides both face detection and identification of the person. Alternatively, where a face is detected in the image using a technique other than a neural network (such as that described above), the neural network procedure may be used to confirm detection of a face and to also provide identification of the face.

As another alternative technique of face recognition and processing that may be programmed in control unit 30, U.S. Pat. No. 5,835,616, “FACE DETECTION USING TEMPLATES” of Lobo et al, issued Nov. 10, 1998, hereby incorporated by reference herein, presents a two step process for automatically detecting and/or identifying a human face in a digitized image, and for confirming the existence of the face by examining facial features. Thus, the technique of Lobo may be used in lieu of, or as a supplement to, the face detection and identification provided by the neural network technique and through the initial tracking of a moving body, as described above. The system of Lobo et al is particularly well suited for detecting one or more faces within a camera's field of view, even though the view may not correspond to a typical position of a face within an image. Thus, control unit 30 may analyze portions of the image for an area having the general characteristics of a face, based on the location of flesh tones, the location of non-flesh tones corresponding to eye brows, demarcation lines corresponding to chins, nose, and so on, as in the referenced U.S. Pat. No. 5,835,616.

If a face is detected, it is characterized for comparison with reference faces for persons in the office (which are stored in database 32), as in the referenced U.S. Pat. No. 5,835,616. This characterization of the face in the image is preferably the same characterization process that is used to characterize the reference faces, and facilitates a comparison of faces based on characteristics, rather than an ‘optical’ match, thereby obviating the need to have two identical images (current face and reference face) in order to locate a match. In a preferred embodiment, the number of reference faces is relatively small, typically limited to the number of people in an office, household, or other small sized environment, thereby allowing the face recognition process to be effected quickly. The reference faces stored in memory 34 of control unit 30 have the identity of the person associated therewith; thus, a match between a face detected in the image and a reference face provides an identification of the person in the image.

Thus, the memory 34 and/or software of control unit 30 effectively includes a pool of reference images and the identities of the persons associated therewith. Using the images received from camera Cx, the control unit 30 effectively detects and identifies a known person (or persons) located in region Rx by locating a face (or faces) in the image and matching it with an image in the pool of reference images. The “match” may be detection of a face in the image provided by a neural network trained using the pool of reference images, or the matching of facial characteristics in the camera image and reference images as in U.S. Pat. No. 5,835,616, as described above.

Data indicating the detection of a known person, for example, employee A, in region Rx is transmitted via line 40 from control unit 30 to PBX 20. Equivalently, control unit 30 may transmit data associating employee A and extension Xx to PBX 20, since extension Xx services region Rx in which employee A is located. Of course, PBX 20 may make the association between extension Xx and region Rx itself PBX 20 makes an updated record that associates employee A and extension Xx.

As noted above, after an incoming call is received by PBX, the caller will typically provide signaling that identifies a desired recipient, for example, employee A. As also noted above, in a traditional mode of operation, the PBX 20 will route the call to a particular extension that is assigned to employee A. For example, signaling provided by the caller may be an indicium of employee A's name or the number for the extension otherwise assigned to employee A (for example, extension X1, which may be employee A's office). Upon receipt of the signaling from the caller indicating employee A is the desired recipient, the PBX 20 in the traditional mode routes the call to extension X1, even in the case where employee A may be located in region Rx.

However, in accordance with the processing comprising this embodiment of the invention, when the caller provides signaling to PBX 20 that indicates that the desired recipient is employee A, PBX 20 accesses the record that associates employee A with extension Xx based on the data received from control unit 30. The call is routed to extension Xx servicing region Rx, where employee A is located.

In like manner, cameras C1, C2, . . . , CN serve to provide images of other regions R1, R2, . . . , RN of the local office environment to control unit 30 over lines L1, L2, . . . , LN. The control unit 30 processes the images associated with each region in the manner described above, thus identifying known persons in the various regions from images for the respective regions. In like manner, for each known person identified in an image, control unit 30 sends data associating the identity of the person with the particular region (or the extension serving the region) to PBX 20. PBX 20 maintains a record that associates each such identified person with the corresponding extension in the region that he or she is located. When an incoming call is received, PBX 20 checks the records for the desired recipient and, if a record exists, routes the call to the associated extension for the desired recipient.

As a person moves from one region to a new region, the camera for the new region will capture the person in the subsequent images that are transmitted to control unit 30. After identification of the person in the image for the new region, control unit 30 will transmit data associating the person with the new region to PBX 20. PBX 20 will replace any existing record for the person with a new record associating the person with the extension serving the new region. Thus, incoming calls for the person will be routed to the extension serving the new region.

For example, if employee A moves from region Rx to region R2 in FIG. 1, the images transmitted from camera C2 to control unit 30 via line 26(2) will include employee A. After image detection and identification processing of the image, control unit 30 identifies employee A in region R2 and transmits data associating employee A with region R2 (or extension X2 serving region R2) to PBX 20. PBX 20 updates its record for employee A by associating employee A with extension R2. Incoming calls for employee A are thus now routed to R2. In like manner, records for all known persons in the various regions are updated in PBX 20 as they move into new regions.

In addition, if a record is made in the PBX 20 associating a person with an extension, but the person is not detected in another image within a predetermined amount of time, the PBX 20 may be programmed to presume that the person has left the office 10 and the record may be deleted. If an incoming call is received for a person or employee where there is no record of an associated extension in the PBX 20, then the call may be routed directly to voice mail 24. Alternatively, it may be switched to the particular extension assigned to the person and, if there is no answer after a number of rings, switched to voice mail 24.

The image processing may also detect gestures in addition to the identity of an employee. The control unit 30 may be programmed to detect certain pre-determined gestures and make appropriate adjustments to the signal sent to PBX 20 for the identified employee making the gesture. For example, as an employee enters a conference room, he or she may hold up three fingers toward the camera. This gesture may indicate that the employee does not want to be disturbed. After detecting the identity of the employee and the gesture from the received image, the control unit 30 sends a signal to the PBX 20 that associates the identified employee with voice mail, instead of the extension for the conference room. The PBX 20 makes an appropriate record and, when an incoming call is received for the employee, it is forwarded to voice mail 24. As noted above, the Mixture Of Experts paper provides further details on recognition of gestures from images.

In the description above, control unit 30 and PBX 20 were depicted and described as separate components. Some of the processing ascribed to the PBX 20 in the description may be performed by the control unit 30 and vice versa. For example, the records associating identified employees with particular extensions may be maintained in the control unit 30. When an incoming call is received by the PBX for an employee, the PBX 20 may query control unit 30 (via line 40) to determine whether a record exists for the employee. The control unit 30 may search the records and, if one is found for the employee, may identify the associated extension to the PBX 20, wherein PBX 20 then makes the appropriate connection. In addition, the control unit 30 and the PBX 20 may be combined into one component.

Cameras C1, C2, . . . , CN are positioned such that they capture images of substantially the entire region R1, R2, . . . , RN, respectively, and, in particular, such that they are likely to capture the faces of persons located in each region. A region may be serviced by more than one camera in order to ensure that the face of a person is captured in the image. Determination of an adequate number of cameras for a region and their position may be determined empirically, for example, by changing the positions and/or the number of cameras and then testing how well a known person is properly identified in different positions in the region. Where a plurality of cameras service a region, a number of images from each camera may be transmitted in a multiplexed fashion over a single line to the control unit 30. Alternatively, there may be a line from each camera in the region to the control unit 30.

Referring back to FIG. 1, both the respective phone and the camera are represented as being within each region. For example, both camera C1 and phone P1 are represented as being in region R1. The figure is only intended to be representative of the relationship between a spatial region, a camera C1 that captures images for that region, and a phone that services the region. The phone does not necessarily have to be within the region it services; for example, it may be a phone that is located outside of a conference room. In such a case, the phone may be answered by a nominee for the desired recipient of a call, such as a receptionist stationed outside the conference room. Before the call is connected, the nominee may be notified of the identity of the desired recipient. The nominee may take the call on behalf of the desired recipient, and/or may alternatively locate the desired recipient (in the example, in the conference room) and alert him or her of the call. Similarly, if an extension serving a region is occupied and the desired recipient of the call is located in the region, then the call may be routed to a phone serving an adjacent region. Before the call is answered by a person in the adjacent region, the system may notify the answering person of the identity of the desired recipient. The person may take the call on behalf of the desired recipient, and/or may alternatively locate the desired recipient and alert him or her of the call.

In addition, the camera does not have to be within a region. It may, for example, provide images that enable the control unit 30 to keep track of persons within a region of the office. Thus, for example, a camera may be located so that it captures images at the entrance of the region it services. For example, a camera may be located at the hallway that leads to a conference room. The images will include facial images of persons entering the conference room, and calls for known persons identified in the images are routed to the phone servicing the conference room. As noted, the local environment may also be, for example, a home serviced by a number of telephones in various rooms. A home may not have a number of separate exchanges serviced by a PBX, as in the above-described embodiment. In general, a home has one or a few telephone lines, each having a separate telephone number, provided directly from the PSTN. Each line is routed to one (or more) telephones, a fax machine, PC, etc.

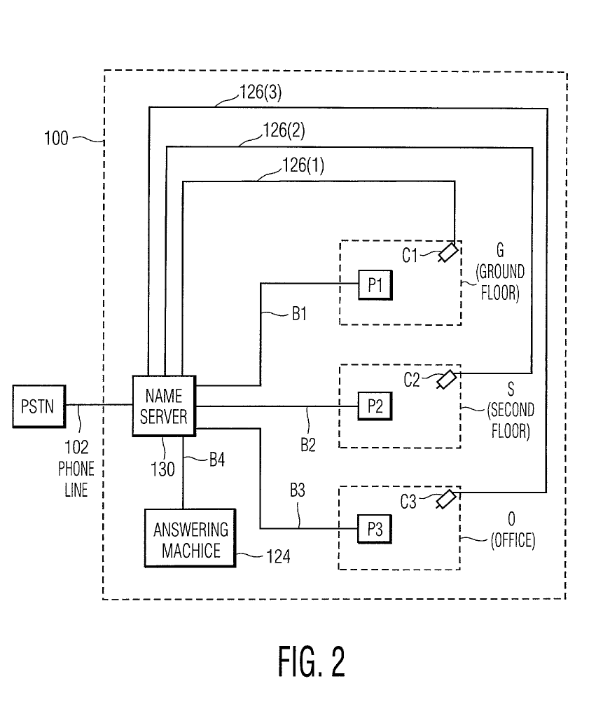

Referring to FIG. 2, another exemplary embodiment of the invention as applied to a home 100 is shown. A single phone line 102 is shown serving the home. The phone line is connected to the PSTN and, for example, supports a telephone number for the home. As also shown in FIG. 2, phone P1 is located on the ground floor G, phone P2 is located on the second floor S and phone P3 is located in the home office O. In a traditional configuration, phone line 102 is divided when it enters the home 100 and connects directly to each phone P1, P2, P3. Thus, an incoming call causes each phone P1, P2, P3 to ring and the incoming call may be picked up on any phone P1, P2 or P3.

In the embodiment of FIG. 2, an incoming call over line 102 is received by home server 130, which also includes a switching network. Each phone P1, P2 and P3 is attached to separate switching terminals of the switching network of home server 130 via branch B1, B2 and B3, respectively. Home server 130 may connect the incoming call to one or more of phones P1, P2 and P3 by switching phone line 102 to connect to one or more of branches B1, B2 and B3, respectively. Thus, for example, home server 130 may connect an incoming call to phone Pi alone by switching phone line 102 so that it connects with branch B1 alone. As another example, home server 130 may connect an incoming call to phones P1 and P3 by switching line 102 to connect with branches B1 and B3.

Camera C1 is positioned to capture images on the ground floor G and transmits the image data to home server via line 126(1). Similarly, camera C2 positioned on second floor S captures images on the second floor S and transmits the image data to home server 130 via line 126(2), and camera C3 positioned in office O captures images of the office and transmits the image data to home server 130 via line 126(3). As noted above, the image data may be pre-processed in the cameras before being sent to the home server 130.

Home server 130 includes image recognition software such as that described above for the first embodiment. In a simple implementation, the image recognition may simply detect the presence of a human body in the image. Thus, home server 130 applies the image detection processing to the images received from cameras C1, C2 and C3 and determines where persons are located in the home 100. If, for example, the server detects a person in the office O, then an incoming call is routed to phone P3 in the office O. If a person is also detected on the second floor S, then an incoming call may be routed to phones P2 and P3. Alternatively, the home server 130 may be programmed to switch to a single branch based on a priority scheme. For example, for the case where a person is detected in the office O and the second floor S, priority may be given to switching the call to the office phone P3 alone.

Multiple cameras may be necessary on the ground floor G, second floor S and/or office O in order to completely cover the regions and detect persons located in the regions. Alternatively, if only one or a lesser number of cameras is feasible than can completely cover a region, then they may be strategically positioned within the region. For example, camera C2 may be positioned at the top of the stairs of the second floor S, thus determining whether a person is on the second floor by keeping track of the number of persons entering and exiting the second floor S. As another example, on the ground floor G, where there may be a number of entrances and exits which cannot be covered by a single camera, camera C1 may be a wide angle camera that is positioned to provide images from the busiest sector or corridor of the ground floor G. Detection of a person in the sector by the server 130, of course, indicates that a call should be routed to phone P1 (unless a prioritization routes the call elsewhere, as described above). The router 130 may also set a timer that continues to switch calls to the ground floor G for a certain amount of time after a person is detected, for example, 15 minutes. In this case, if a person on the ground floor G moves to another area that is not covered by camera C1, the call is still routed to the ground floor. If a person is not again detected in the busiest sector during that time interval, the timer times out and home server 130 concludes that nobody is present on the ground floor G and does not route the call to P1.

Similar to the first embodiment, if the server 130 does not detect any persons in any of the regions of the home, then the call may be switched to the home answering machine 124 via line B4. Alternatively, all phones P1, P2, P3 may be connected and allowed to ring a certain number of times, in the event that somebody is present in the house but has not been detected. If there is nobody answers on any of the phones, then the call may be switched to the answering machine.

In a more advanced version of the embodiment, the software of the home server 130 not only detects persons, but also identifies known persons in the images received from the cameras, using, for example, one of the identification processing techniques discussed above for the first embodiment. A call is routed to the ground floor G, second floor S or office O when a known person is identified in the image received from the respective camera covering that region. If two or more known persons are identified from the images as being in different regions, the call may be routed to one or multiple regions where the known persons are located. For example, a first known person may be identified in the images sent from camera C2 as being on the second floor S and a second known person may be identified in the images sent from camera C3 as being in the office O. An incoming call may thus be routed to both phones, namely phone P2 serving the second floor S and phone P3 serving the office O. However, the home server 130 may also prioritize among known persons, thus routing the call only to the identified person with the higher priority. For example, if the second known person identified has a higher priority programmed in the home server 130 than the first known person, the call is routed to the second known person via line B3 to phone P3 in the office O.

Where the server 130 identifies known persons from the received images, it may use the information to keep track that a person has left one region when he or she is subsequently identified in a different region. Thus, for example, if known person A is identified as being on the ground floor G, the server 130 may route incoming calls to phone P1. At a later time, if person A is identified as being on the second floor S and no other persons have been detected on the ground floor G, then the server 130 determines that nobody is on the ground floor G. An incoming call may thus be routed to phone P2 on the second floor S.

Voice detection in the various regions and voice recognition processing may be used instead of (or as a supplement to) the image detection and processing in the invention. One skilled in the art will readily recognize how to adapt, for example, the above-described embodiments to use voice detection and voice recognition processing. For example, the cameras associated with the regions may be replaced with microphones. The control unit may be programmed with known processing that detects voices and/or identifies known voices in the various regions. Other facets of the above-described embodiments remain the same or are adapted in a straight-forward manner.

The following five documents are hereby incorporated by reference herein:

1) “Pfinder: Real-Time Tracking Of the Human Body” by Wren et al., M.I.T. Media Laboratory Perceptual Computing Section Technical Report No. 353, published in IEEE Transactions on Pattern Analysis and Machine Intelligence, vol. 19, no. 7, pp 780-85 (July 1997), which describes a “person finder” that finds and follows people's bodies (or head or hands, for example) in a video image

2) “Pedestrian Detection From A Moving Vehicle” by D. M. Gavrila (Image Understanding Systems, DaimlerChrysler Research), Proceedings of the European Conference on Computer Vision, Dublin, Ireland (2000) (available at www.gavrila.net), which describes detection of a person (a pedestrian) within an image using a template matching approach.

3) “Condensation—Conditional Density Propagation For Visual Tracking” by Isard and Blake (Oxford Univ. Dept. of Engineering Science), Int. J. Computer Vision, vol. 29, no. 1, pp. 5-28 (1998) (available at www.dai.ed.ac.uk/CVonline/LOCAL COPIES/ISARD1/condensation.html, along with the “Condensation” source code), which describes use of a statistical sampling algorithm for detection of a static object in an image and a stochastical model for detection of object motion.

4) U.S. patent application Ser. No. 09/685,683 entitled “Device Control Via Image-Based Recognition” of Miroslav Trajkovic, Yong Yan, Antonio Colmenarez and Srinivas Gutta, filed Oct. 10, 2000, Attorney docket US000269, which provides further description of image recognition.

5) U.S. patent application Ser. No. 09/800,219 entitled “Automatic Positioning Of Display Depending Upon The Viewer's Location” for Srinivas Gutta, et al., filed Mar. 5, 2001, Attorney docket US010050, which provides further description of face detection in a moving and/or static image.

In addition, it is noted that software that can recognize faces in images (including digital images) is commercially available, such as the “Facelt” software sold by Visionics and described at www.faceit.com.

Although illustrative embodiments of the present invention have been described herein with reference to the accompanying drawings, it is to be understood that the invention is not limited to those precise embodiments, but rather it is intended that the scope of the invention is as defined by the scope of the appended claims.

What is claimed is:

1. A system comprising a control unit that receives images associated with two or more regions of a local environment, the two or more regions each being serviced by a respective telephone extension, the control unit processing the images to identify, from a group of known persons associated with the local environment, any one or more known persons located in the respective regions and, for each known person so identified, generating an indicium that associates the known person with the respective region in which the known person is located.

2. The system of claim 1 further comprising two or more cameras that provide the images associated with the two or more regions of the local environment, each region having associated therewith at least one of the two or more cameras, wherein images captured by the at least one camera associated with each region are processed to identify any known persons located in the respective region.

3. The system of claim 1, wherein the indicium generated by the control unit, for each known person identified, that associates the known person with the respective region in which the known person is located is incorporated in a signal.

4. The system of claim 3 further comprising a private branch exchange (PBX), wherein the signal is output by the control unit to the PBX.

5. The system of claim 4, wherein, for each known person identified, the PBX uses the signal to create a record that associates the known person with the telephone exchange servicing the respective region in which the known person is located.

6. The system of claim 5, wherein, when the PBX receives an incoming call for one known person of the group of known persons and determines that one of the records relates to the one known person, the PBX connects the call to the telephone extension associated with the one known person in the record.

7. The system as in claim 1, wherein the indicium, for each known person identified, that associates the known person with the respective region is incorporated in a record maintained in the control unit.

8. The system as in claim 1, wherein the control unit switches an incoming call to at least one of the respective telephone extensions servicing at least one of the two or more regions in which at least one identified known person is located.

9. A system comprising a control unit that receives images associated with two or more regions of a local environment, the two or more regions each being serviced by a respective telephone branch, the control unit processing the images to detect any persons located in the respective regions and switching an incoming call to at least one of the respective telephone branches in which at least one detected person is located.

10. A method for directing an incoming telephone call, the method comprising the steps of:
a) capturing images associated with each of a number of regions of a local environment;
b) identifying, from a group of known persons each associated with the local environment, any known persons in each of the number of regions from the captured images associated with each of the number of regions;
c) identifying a desired recipient of the incoming call;
d) determining whether the desired recipient is one of the known persons identified in one of the regions in step b; and
e) where the desired recipient is one of the known persons identified in one of the regions in step b, connecting the incoming call to an extension servicing the respective region in which the desired recipient is located.

11. The method of claim 10, wherein the step of capturing images associated with each of a number of regions comprises, for one or more of the regions, directing at least one camera at at least a portion of the region.

12. The method of claim 10, wherein the step of capturing images associated with each of a number of regions comprises, for one or more of the regions, positioning a camera to capture images at an entrance of the region.

13. The method of claim 10, wherein the step of identifying any known persons from the captured images includes applying image recognition processing to the images.

14. The method of claim 13, wherein the application of the image recognition processing to the images includes accessing a database of image data for the group of known persons.

15. The method of claim 10 wherein step b further comprises creating a record associating each known person identified from the captured images with the respective region in which the known person is located.

16. The method of claim 15, wherein the step of determining whether the desired recipient is one of the known persons identified in one of the regions in step b comprises searching the records relating to each known person and the respective region in which the known person is located.

17. A method for directing an incoming telephone call, the method comprising the steps of:
a) capturing images associated with each of a number of regions of a local environment;
b) detecting any persons located in each of the number of regions from the captured images associated with each of the number of regions; and
c) connecting an incoming call to an extension servicing at least one of the regions in which at least one person is located.
